(19) United States
(12) Patent Application Publication
(10) Pub. No.: US 2022/0268515 A1
(43) Pub. Date: Aug. 25, 2022

(54) GAS LIQUEFACTION USING HYBRID PROCESSING

(71) Applicant: Energy Internet Corporation, Saratoga, CA (US)

(72) Inventors: Shankar Nataraj, Allentown, PA (US); Paul M. Mathias, Aliso Viejo, CA (US); Shankar Ramamurthy, Saratoga, CA (US); Steven F Sciamanna, Orinda, CA (US)

(21) Appl. No.: 17/726,589

(22) Filed: Apr. 22, 2022

Related U.S. Application Data
(63) Continuation-in-part of application No. 16/747,843, filed on Jan. 21, 2020.
Application No. 16/747,843 is a continuation-in-part of application No. 16/378,243, filed on Apr. 8, 2019, now Pat. No. 10,947,899.
Application No. 16/378,243 is a continuation-in-part of application No. 16/118,886, filed on Aug. 31, 2018, now Pat. No. 10,725,441.
(60) Provisional application No. 63/316,432, filed on Mar. 4, 2022.
(60) Provisional application No. 63/246,813, filed on Sep. 22, 2021.
(60) Provisional application No. 63/227,499, filed on Jul. 30, 2021.
(60) Provisional application No. 63/178,560, filed on Apr. 23, 2021.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.
(60) Provisional application No. 62/654,859, filed on Apr. 9, 2018.

(51) Int. Cl. F25J 1/00; F28D 20/00; F04B 19/04; F04B 53/08

(52) U.S. Cl. CPC F25J 1/0012; F28D 20/0043; F04B 19/04; F04B 53/08; F25J 1/0047; F25J 1/0032

(57) ABSTRACT

Disclosed techniques include gas liquefaction using hybrid processing. A gas is compressed adiabatically to produce a compressed gas at a first pressure. The compressing a gas adiabatically is accomplished using one or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure. The gas that was liquefied is stored for future use. The gas that was liquefied is used to perform work.

### RELATED APPLICATIONS

This application claims the benefit of U.S. provisional patent applications “Gas Liquefaction Using Hybrid Processing” Ser. No. 63/178,560, filed Apr. 23, 2021, “Recovery of Work from a Liquefied Gas Using Hybrid Processing” Ser. No. 63/227,499, filed Jul. 30, 2021, “Hybrid Compressed Air Energy Storage System Using Paired Liquid Pistons” Ser. No. 63/246,813, filed Sep. 22, 2021, and “Hybrid Compressed Air Energy System Using Liquid Pistons” Ser. No. 63/316,432, filed Mar. 4, 2022.

This application is also a continuation-in-part of U.S. patent application “Energy Management Using a Converged Infrastructure” Ser. No. 16/747,843, filed Jan. 21, 2020, which claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

The U.S. patent application “Energy Management Using a Converged Infrastructure” Ser. No. 16/747,843, filed Jan. 21, 2020 is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan, 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to gas processing and more particularly to gas liquefaction using hybrid processing.

### BACKGROUND

The growth of municipalities, counties, states, and countries has largely driven energy demand. While some countries are actively reducing their energy demands and revamping their energy infrastructures, others are constructing power plants that burn fossil fuels, nuclear facilities, hydroelectric dams, and other traditional and often controversial energy generation sources. The development of rural and previously underserved areas further propels increased energy demand. Improved living standards give rise to increased demand, particularly in rural areas, requiring both the installation of electrical and communications infrastructures, and the expansion of transportation networks. Growing populations further increase energy demand as more people consume energy for cooking, bathing, cleaning, laundry, and entertaining. Energy is additionally consumed for illuminating, heating, and cooling houses or apartments, businesses, and government buildings. Expanded economic activities, including retail, public transportation, and manufacturing, among many others, increase energy demand.

Many stakeholders associated with energy, including government agencies, energy producers, and conservation minded consumers big and small, endeavor to reduce their energy consumption. These parties are motivated to craft, initiate, practice, and enforce energy conservation measures for environmental and economic reasons. Consumers can decrease their energy footprints by altering their heating and cooling habits; turning off lights when leaving a room; and purchasing energy-efficient appliances, electronic consumer products, and automobiles. Each of these popular tasks is a simple step toward conserving energy and reducing cost. Yet while these and other conservation efforts are helpful, the demand for energy of all types outstrips the conservation savings alone. The growth of towns, cities, states, and countries increases the demand for energy of all kinds, resulting in what many analysts identify as an energy crisis. Increasing energy demand has many dimensions. Increased demand and overconsumption of energy impose strains on natural resources and renewable resources alike, resulting in fuel shortages, rising costs, and increased environmental destruction and pollution.

Energy distribution remains a nettlesome hindrance to solving the energy crisis. The existing energy distribution infrastructure is oversubscribed. Further, the infrastructure is often unavailable to potential new energy sources including renewable energy, which remains largely unexplored or underdeveloped. There is vociferous objection by adjacent landowners and others to siting of mountaintop or offshore wind turbines, solar farms, or wood burning plants. Even when designs can be drafted and permits obtained to construct renewable energy producing facilities, the distribution of the energy is impeded by the poor distribution infrastructure. Landowners are reluctant to agree to high tension lines traversing their property, particularly when the power is destined for consumers “from away”. Commissioning new energy generation facilities remains a seemingly insurmountable challenge. Energy loss and wastage further remain major impediments. Aging appliances or manufacturing equipment, incandescent light bulbs, and poor building insulation and air sealing, all waste energy in comparison to their modern counterparts. Public officials, planners, and others are compelled to choose from among three broad energy solutions: to increase energy production, to reduce energy demand through energy conservation, or to implement a combination of both of these strategies.

### SUMMARY

Traditional and renewable generation sources can be used to produce energy. Energy consumption typically increases or decreases over a given period of time, resulting in dynamic differences between energy production and energy consumption. These differences can further depend on a timeframe such as day versus night, a day of the week, manufacturing schedules, payroll processing, seasonal factors such as heating or cooling, and so on. The discrepancies between energy production and energy consumption can be substantial and at times acute. The discrepancies can be correlated to time-dependent energy demands, to changeable energy production capabilities, such as the presence or absence of a renewable resource used to generate the energy, to available capacity of commercial or grid power, to the amount of standby or backup energy, etc. To ameliorate the asymmetry between energy production and consumption, energy that is in excess to demand at a given time can be stored for later use. The stored energy can be recovered at a later time when demand exceeds a given power level or supply capability. Energy can be collected and stored when a renewable resource is available, when the available energy exceeds energy need, or even when the cost of production of the energy is relatively inexpensive. The stored energy can be used to augment available energy or to provide the amount of energy that is needed during periods of increased or otherwise unmet energy need. The recovery of stored energy can be applied to low-level energy demand scenarios, such as the energy needs of a house or small farm operation, to larger scale energy needs such as the energy needs for manufacturing, or even to the largest energy needs such as an energy distribution grid.

Disclosed techniques address gas liquefaction using hybrid processing. A gas is compressed adiabatically to produce a compressed gas at a first pressure. The compressing a gas adiabatically is accomplished using one or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure. The gas that was liquefied is stored for future use. The gas that was liquefied is used to perform work.

A computer-implemented method for gas processing is disclosed comprising: compressing a gas adiabatically to produce a compressed gas at a first pressure; extracting heat from the compressed gas at a first pressure; and further compressing the compressed gas at a first pressure, wherein the further compressing is accomplished using a first liquid piston compressor, and wherein the further compressing produces a compressed gas at a second pressure. The method can include cooling the compressed gas at a second pressure using a heat exchanger. The cooling can accomplish liquefaction of the compressed gas at a second pressure. The heat exchanger can be cooled using a refrigeration system. The method can include additionally compressing a portion of the compressed gas at a second pressure, using a second liquid piston compressor, to produce a compressed gas at a third pressure. The first and/or the second liquid piston can be cooled. The cooling can be accomplished using a liquid spray. The liquid spray can include a variety of liquids including an environmental water spray. In embodiments, cooling the first liquid piston compressor enables isothermal operation of the first liquid piston compressor. In further embodiments, the compressed gas at a second pressure is dried before liquefaction occurs. The drying of the compressed gas can remove vapor such as water vapor from the compressed gas. The removing water vapor can prevent freeze-up of the liquid piston. The compressing, the extracting, the further compressing, and the cooling can be controlled using a computing device.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for gas liquefaction using hybrid processing.

FIG. 2 is a flow diagram for second liquid piston usage.

FIG. 3 is a block diagram of a compressed air energy system (CAES).

FIG. 4 is a system block diagram for liquid spray.

FIG. 5 is a system block diagram for adiabatic compression before a first liquid piston.

FIG. 6 is a system block diagram for water piston compression.

FIG. 7 is a system block diagram for a refrigeration loop.

FIG. 8 is a system block diagram for liquid air extraction.

FIG. 9 is a system block diagram of a liquid piston compressor.

FIG. 10 is a system block diagram for hybrid compression.

FIG. 11 is a system block diagram for hybrid compression with an additional liquid piston.

FIG. 12 is a system diagram for gas liquefaction using hybrid processing.

### DETAILED DESCRIPTION

This disclosure provides techniques for gas liquefaction using hybrid processing. Gas processing can be managed, where the gas processing can include liquefying a gas, storing the liquefied gas, capturing heat generated when processing the gas, and extracting energy from the gas. The energy extracted from the liquefied gas can be converted to another energy type such as electrical energy. Energy management is based on storing energy such as grid energy, renewable energy, and so on, using a liquefied gas. The liquefied gas can be stored in a holding tank such as a cryogenic tank. The holding tank can be part of a large-scale energy storage subsystem which can store energy from one or more points of generation. The stored energy can be provided after a period of time to meet unmet energy demands such as energy demands of dynamic loads. The energy that is stored using the liquefied gas can be received from diverse and disparate energy sources. Energy can be shaved or harvested and stored when the amount of energy available from the points of generation exceeds the energy demand at the time of energy generation. The energy can be stored for a period of time. The energy storage includes electrical energy storage using batteries or capacitors. The energy storage can include multiple pressurized storage elements such as compressed air storage elements. The energy storage includes the one or more liquefied gases within a holding tank. The storage of the energy and the recovery of the energy can include use of a liquid piston, a water piston heat engine (WPHE), and so on. Managing the sourcing, storing, and transforming of energy, while minimizing energy losses, is a complex and highly challenging task. Energy management can be influenced by many factors including the weather, dynamic and often wildly varying energy demands, variable pricing schemes, and so on. Energy management can be further complicated by quickly changing customer energy demands, requirements of service level agreements (SLAs), etc. Despite the growing use of renewable energy resources such as solar, wind, wave action, tidal, geothermal, biogas, and the like, two significant challenges remain: the amount of energy produced by a given renewable energy source is highly variable, and the availability of the renewable energy source is inconsistent. As an example, wind energy is only available when wind is present, solar energy only when the sun is shining, wave action energy only when waves are present, and so on.

Energy with intermittent availability or excess energy can be stored or cached when the energy is being produced, and can be extracted at a later time when the stored energy is needed. A similar strategy can be used based on price, where energy is stored when production cost is low, then later extracted when the energy production cost is high. The stored energy can be used in various combinations with other energy sources such as grid power or microgrid (e.g., locally generated) power to meet energy demands at given times. Energy storage can be based on a period of time, where the period of time can be a short-term basis or a long-term basis. Energy losses are introduced when converting energy from one energy type to another energy type. Further losses occur when storing energy, extracting energy, routing energy, etc. Minimizing the energy losses is critical to any energy storage and retrieval/recovery technique. Electrical energy storage is possible using techniques such as mature storage battery technologies, but the costs of large battery banks are prohibitive in terms of both up-front expense and maintenance costs. Further, batteries are problematic for long-term storage purposes because of charge leakage.

In disclosed techniques, gas liquefaction uses hybrid processing. Energy in excess to demand can be captured, converted to another energy form such as a liquefied gas, and stored for later use. The energy can be obtained locally using an onsite microgrid, or from farther afield using a larger grid such as a regional or national grid. The energy can be generated using fuels such as coal, natural gas, or nuclear sources; using hydro power or geothermal energy; using renewable sources such as solar, wind, tidal, wave action, biofuels, or biogas; using pump-turbine sources such as compressed air, steam, or ice; using backup power sources such as diesel-generator sets; and so on. A gas is compressed adiabatically to produce a compressed gas at a first pressure. The compressed gas is further compressed using a liquid piston. The liquid used for the compressing can include a liquid such as water. Gas liquefaction using hybrid processing can include an initial compression of a gas, which can be accomplished using conventional compressors operating adiabatically, and a subsequent further compression of the gas, which can be accomplished using liquid pistons. Using liquid pistons in place of conventional compressors can lead to cost, efficiency, and/or reliability advantages. The size of a liquid piston and the water flows required to accomplish liquid piston compression is proportional to the inlet density of the gas being compressed. At low pressures, it is well known that gases have a lower density than at higher pressures. For an ideal gas, this is manifest in the well-known ideal gas equation of state: PV=nRT.

Energy storage can be based on requirements including energy storage and conversion. Energy can be stored and converted using a liquefied gas processing system based on compressing and cooling a gas. The liquefied gas system can include compressing stages, heat extractors, heat exchangers, and thermal stores. The liquefied gas can be stored in a storage vessel such as a cryogenic tank, and the extracted heat can be stored in a thermal store such as a bed of packing, a heat exchanger filled with a heat-storing liquid, etc. The liquefied gas processing system can be part of a larger energy management system that includes one or more large-scale energy storage subsystems. The large-scale energy storage subsystem can store electrical energy, potential energy, thermal energy, kinetic energy, etc. A gas is compressed adiabatically to produce a compressed gas at a first pressure. The gas compression can be accomplished using two or more compressing stages. The compressing stages can be electrically operated. Heat is extracted from the compressed gas at a first pressure. The heat can be extracted using a heat exchanger. The heat that is extracted can be collected in a thermal store. The compressed gas at a first pressure is further compressed. The further compressing is accomplished using a first liquid piston compressor, and the further compressing produces a compressed gas at a second pressure. The liquid piston compressor can include a gas such as air and a liquid such as water. The compressed gas at a second pressure is cooled using a heat exchanger, where the cooling accomplishes liquefaction of the compressed gas at a second pressure. Further cooling can include cooling the first liquid piston compressor using a liquid spray. The liquid spray can be introduced into the first liquid piston compressor in a region occupied by the gas. The liquid spray cooling the first liquid piston compressor enables isothermal operation of the first liquid piston compressor. Isothermal compressing maintains a constant or near-constant temperature of the gas being compressed. The liquid spray can be a similar substance to the liquid piston liquid which is used to compress the gas that is being pressurized, or it can be a dissimilar substance. The dissimilar substances of the liquid piston liquid and the cooling spray can later be separated or isolated.

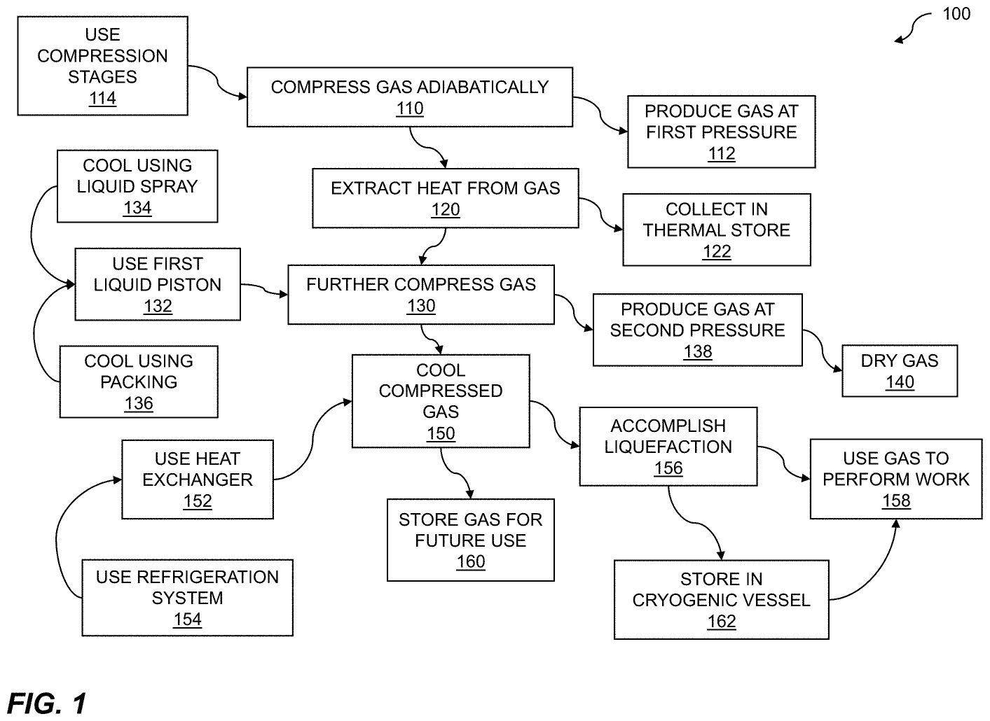

FIG. 1 is a flow diagram for gas liquefaction using hybrid processing. Gas liquefaction can enable energy storage, recovery, and management. A gas liquefaction subsystem can store various forms of energy such as electrical energy by storing the energy as one or more liquefied gases. The liquefied gas can be stored in holding tanks. The energy can be stored based on a liquid phase of the gas that is being compressed. The gas liquefaction energy management subsystem can be part of a large energy storage subsystem, where the energy storage subsystem can include multiple batteries or capacitors; pressurized storage elements such as high-pressure water, pressurized air, steam, ice-water slurry; and the like. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A flow 100 for gas liquefaction using hybrid processing is shown. Gas liquefaction can be accomplished by liquefying a gas which is being compressed using one or more compressing states. Energy, such as electrical energy from a traditional electrical grid, energy from renewable sources, and so on, can be stored. Thermal energy, mechanical energy, pressure, and other forms of energy can also be stored. The energy can be transformed into an energy format which can be stored for a length of time. Energy management can be used for storing, retrieving, or extracting energy from an energy storage subsystem such as a gas liquefaction subsystem. The energy storage subsystem can be a large-scale energy storage subsystem or can be a small-scale energy storage subsystem. The energy storage subsystem can be based on battery storage, capacitor storage, inductive storage, compressed air storage, steam or ice storage, ice-water slurry, and so on. Described herein, the energy storage subsystem can include a gas liquefaction subsystem based on hybrid processing. A gas liquefaction storage subsystem can include energy storage elements such as high-pressure chambers, compression-expansion chambers, compressed air chambers, and so on. The energy storage subsystems can include one or more cryogenic vessels. A gas liquefaction system using hybrid processing can be implemented within a cryogenic tank. The storage elements of an energy storage subsystem can store various energy types including electrical energy, thermal energy, kinetic energy, mechanical energy, hydraulic energy, and so on.

The flow 100 includes compressing a gas adiabatically 110. In adiabatic compression, the work energy of compression performed on the fluid being compressed is not removed, but is substantially retained by the fluid, thereby increasing its heat content. Various types of gases can be compressed adiabatically. Discussed throughout, the gas which can be pressurized can include gases such as air, NH₃, CH₄, natural gas, or Freon™ vapors. In embodiments, the gas can include environmental air. Environmental air can include the atmospheric air present in and around an air compressing facility, for example. The gas that is compressed can contain contaminants which can be removed prior to pressurizing the gases. Depending on the gas, the contaminants can include dust, pollen, hair, insects, and so on. The gases can be decontaminated prior to compressing to improve efficiency of the compressing; to prevent blockages within pressure tanks, valves, or pipes; for safety; and so on. The decontaminating can be based on mechanical filters, electrostatic filters, deionization, dehydration, etc. The flow 100 includes producing a compressed gas 112 at a first pressure. The first pressure can include an optimized pressure, a target pressure, a range of pressures, and so on. In embodiments, the first pressure can be in the range of 1 to 50 atmospheres. In the flow 100, the compressing a gas adiabatically is accomplished using one or more compressing stages 114. The compressing stages can be based on various compressing techniques such as centrifugal, reciprocating, axial, and rotary screw compressing techniques. In embodiments, the compressing can be accomplished using one or more of centrifugal and reciprocating compressors. In embodiments, the compressing a gas adiabatically is accomplished using two or more compressing stages.

The flow 100 includes extracting heat 120 from the compressed gas after compression to the first pressure. As a gas is compressed, the temperature of the gas can rise significantly. Removing heat from the compressed gas lowers its temperature, which reduces the power required to compress it further. It also reduces the thermal stresses and requirements of the compressor internals. The heat can be extracted using a heat exchanger, a packed bed, etc. The heat that is removed can be discarded into the environment, either directly through an air cooler, or indirectly through cooling water and cooling towers. Alternatively, the heat that is extracted can be stored. In the flow 100, the heat that is extracted is collected 122 in a thermal store. The thermal store can be housed in a vessel external to a liquid piston vessel, but directly in the path of the compressed gas. Various techniques can be used to enable the thermal store. In embodiments, the thermal store can include a bed of packings. The bed of packings, such as a bed of alumina or other ceramic balls, tiles, or structured packings, comprises materials that can store heat for an extended period of time. Other materials can be used to store extracted heat. In embodiments, the thermal store can include a heat exchanger filled with a heat storing liquid. The heat storing liquid can include water, water mixed with other liquids such as glycol, mineral oils, synthetic thermal fluids, molten inorganic salts, molten metals, and so on.

The flow 100 further includes further compressing the compressed gas 130 at a first pressure. The compressing the compressed gas at the first pressure can be accomplished using one or more of the compressors described previously. In the flow 100, the further compressing is accomplished using a first liquid piston compressor 132. The liquid piston can comprise a vessel into which liquid is pumped in order to compress a gas or vapor trapped in its headspace. As the gas volume is reduced, its pressure increases. When a target pressure is reached, a valve opens and the gas is pushed out of the vessel. The gas within the liquid piston can include ambient, or environmental, air or one or more other gases. The liquid within the liquid piston can include a variety of liquids such as water. As the liquid piston compressor is used to compress the compressed gas at the first pressure, significant amounts of heat can be generated by the compressing. The first liquid piston compressor can be cooled. In the flow 100, the first liquid piston compressor can be cooled using a liquid spray 134. Discussed above, the liquid spray can include a substance substantially similar or identical to the liquid used with the liquid piston, or it can be a substantially dissimilar substance. In embodiments, the liquid spray can include an ambient, or environmental, water spray. The environmental water for the water spray can be naturally occurring water in a body of water such as a lake, a river, a pond, an aquifer, located near a gas compression facility. The environmental water could also include another nearby manmade water supply such as a pumped or well water system, a sump, a reclaimed wastewater facility, a manmade lake or pond, etc. The liquid spray can be conditioned prior to being sprayed into the liquid piston. In embodiments, the liquid spray can be conditioned to an environmental temperature. The environmental temperature can include an indoor ambient temperature, and outdoor temperature, etc. The environmental temperature can include passive heating via solar heat or passive cooling via nighttime air. The liquid spray is introduced into the first liquid piston in a region occupied by the gas. Compressing a gas can generate significant amounts of heat. The increase in temperature progressively increases the work required to compress the gas. The increased temperature can increase mechanical stresses or the requirements of equipment. To minimize the work required for compression, a liquid spray can be used to remove generated heat from the compressing. The droplets within the spray can absorb the generated heat. In embodiments, cooling the first liquid piston compressor can enable isothermal operation of the first liquid piston compressor. An isothermal process is one in which the temperature of the process remains substantially constant. Isothermal pressurizing can maintain a constant or near-constant temperature within the gaseous headspace above the liquid piston. This minimizes the work required for gas pressurization. As an alternate to the spray, the flow 100 can include cooling the gas in the first liquid piston compressor using a packing 136. In contrast with the external thermal store discussed previously, this packing is only designed to store the heat of compression for the duration of one cycle of the liquid piston—typically seconds or minutes. The packing then gets periodically quenched by the liquid comprising the liquid piston, thereby cooling it so it is ready to absorb the heat of compression during the next cycle. Cyclic operation of the liquid piston, and of several similar liquid pistons in parallel but out-of-phase with each other, to generate a continuous output stream, is described in more detail later.

In the flow 100, the further compressing produces a compressed gas at a second pressure 138. In embodiments, the second pressure can be in the range of 5 to 200 atmospheres. The flow 100 includes drying the compressed gas 140 at a second pressure before liquefaction occurs. The drying the compressed gas can remove vapor, such as water vapor, from the compressed gas. The removing vapor from the compressed gas can reduce or eliminate desublimation of the vapor, which can cause freeze-up issues in downstream equipment.

The flow 100 includes cooling the compressed gas 150 at a second pressure below its dew point at that pressure, so that it generates a liquefied gas, which is a desired product. The cooling can be accomplished using a variety of techniques. In the flow 100, the cooling is accomplished using a heat exchanger 152. Various types of heat exchangers, such as plate and fin heat exchangers, can be used. The removal of heat can accomplish liquefaction of the compressed gas. In the flow 100, the compressed gas can be cooled in the heat exchanger using an auto-refrigeration loop by using a portion of the compressed gas that has been isentropically expanded to low pressure such that its temperature is lower than the dew point of the compressed gas at its second pressure. It can, optionally, be pre-cooled prior to this step using a refrigeration system 154. The refrigeration system can include a standard refrigeration loop, where the refrigeration loop comprises a condenser, an evaporator, an expansion valve, and a compressor. In the flow 100, the cooling accomplishes liquefaction 156 of the compressed gas at a second pressure. Noted above and throughout, the gas can include environmental air, a specialized gas, and so on. Some embodiments comprise expanding the compressed gas at the second pressure to provide refrigeration below a target dew point temperature. In embodiments, the expanding is substantially isentropic. In embodiments, the refrigeration is employed to generate liquefied gas at a pressure above a target dew point pressure. Some embodiments comprise feeding the compressed gas at the second pressure that was expanded back into an input of an adiabatic compressor used in the compressing the gas adiabatically. Some embodiments comprise feeding the expanded gas back into the first liquid piston compressor.

The flow 100 further includes using the gas that was liquefied 158 to perform work. The work that is performed can be based on a variety of energy types. The energy types can include electrical, mechanical, or chemical energy, and so on. In embodiments, the work that is performed is enabled by the heat collected in the thermal store. The work that is performed can perform a variety of tasks, actions, and so on. In embodiments, the work includes datacenter cooling. The flow 100 further includes storing the gas 160 that was liquefied for future use. Discussed throughout, the future use can include cooling applications such as cooling a datacenter, power generation by spinning a turbine, and so on. The storing the liquefied gas can include storing the gas in one or more vessels such as one or more pressure containment vessels, a high-pressure vessel, and so on. In the flow 100, a cryogenic vessel 162 is used for storing the gas that was liquefied when the liquefied gas is a cryogenic gas. The vessel 162 can be a double walled vessel with a vacuum between the walls. The cryogenic storage can be based on one or more cryogenic liquid columns.

The compressing, extracting, further compressing, and cooling can be controlled using a computing device. The computing device can include a component within the energy management system. The computing device can include a central processing unit (CPU), a microcontroller, a processor, and so on. The computing device can include a processing core within a programmable device such as a field programmable gate array (FPGA). The computing device can include a processing core within an application specific integrated circuit (ASIC).

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

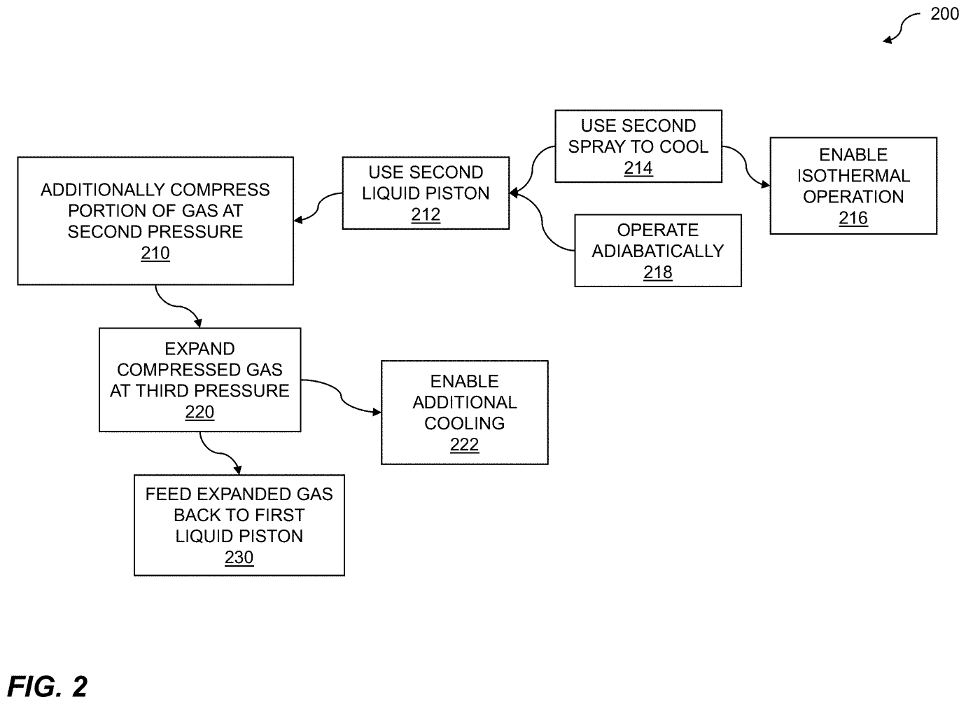

FIG. 2 is flow diagram for second liquid piston usage. The second liquid piston can be used to additionally compress some or all of the gas at a second pressure. The additionally compressed gas produced by the second liquid piston can be stored or used to generate auto-refrigeration by expanding and running an engine or a turbine that exports work. Refrigeration generated by the gas compressed by the second liquid piston supports gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

The flow 200 includes additionally compressing 210 a portion of the compressed gas at a second pressure. The additional compressing can be accomplished using a pump, a pump-turbine, a compressor, and so on. The flow 200 further includes using a second liquid piston compressor 212 to produce a compressed gas at a third pressure. In embodiments, the third pressure can be substantially similar to the second pressure. The third pressure can be substantially above the second pressure. As for the compressing associated with the first liquid piston compressor, a substantial amount of heat can be generated by the compressing. The flow 200 includes cooling the gaseous headspace in the second liquid piston compressor using a liquid spray 214. The substance comprising the liquid spray can include a substance substantially similar to the liquid used as the liquid piston. In embodiments, the liquid spray can include liquid water. In the flow 200, cooling the second liquid piston compressor enables isothermal operation 216 of the second liquid piston compressor. Operating the liquid piston compressor isothermally can substantially reduce the work of compression. As an alternative to the liquid spray, a packing can be used to temporarily absorb the heat of compression in the gaseous headspace only to be released as soon as it gets quenched and wetted by the ascending liquid piston. Alternately, in the flow 200, the first liquid piston compressor (discussed above) and/or the second liquid piston compressor can operate substantially adiabatically 218. In this case, the heat of compression would be removed from the gas and stored external to the second liquid piston. In contrast to the packing internal to the liquid piston in the isothermal compression, this packing is external to the liquid piston vessel.

The flow 200 includes expanding the compressed gas 220 at a third pressure. The expanding the compressed gas can be used to provide refrigeration to a liquefaction system by performing work such as spinning a turbine or running an engine. In embodiments, the work that is performed can include datacenter cooling. As the compressed gas at a third pressure is expanded, the gas can cool, where the cooling can be significant, and below the dew point of the gas at the second pressure. In the flow 200, the expanding the compressed gas at a third pressure enables additional cooling 222 of the compressed gas at a second pressure using an additional heat exchanger to its dew point temperature, such that substantially all of it is liquefied. Discussed previously, recall that a heat exchanger can be used to cool a gas that is being compressed. One or more further heat exchangers can be used to additionally cool a gas that is being compressed. The flow 200 includes feeding the compressed gas 230 at a third pressure that was expanded back into an input of the first liquid piston compressor. Feeding back of the gas to the first liquid piston compressor can enable reuse of the gas. Usage of such a recycled gas stream repeatedly, by alternate near-isothermal compression at near-ambient temperature, followed by near-isentropic expansion to a lower temperature, is defined as a refrigeration loop. If the fluid used for recycling in such a recycle loop is substantially the same as the gas being liquefied, such a loop can also be called an auto-refrigeration loop. Fresh gas can be used to supplement the gas that is fed back to the first liquid compressor.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

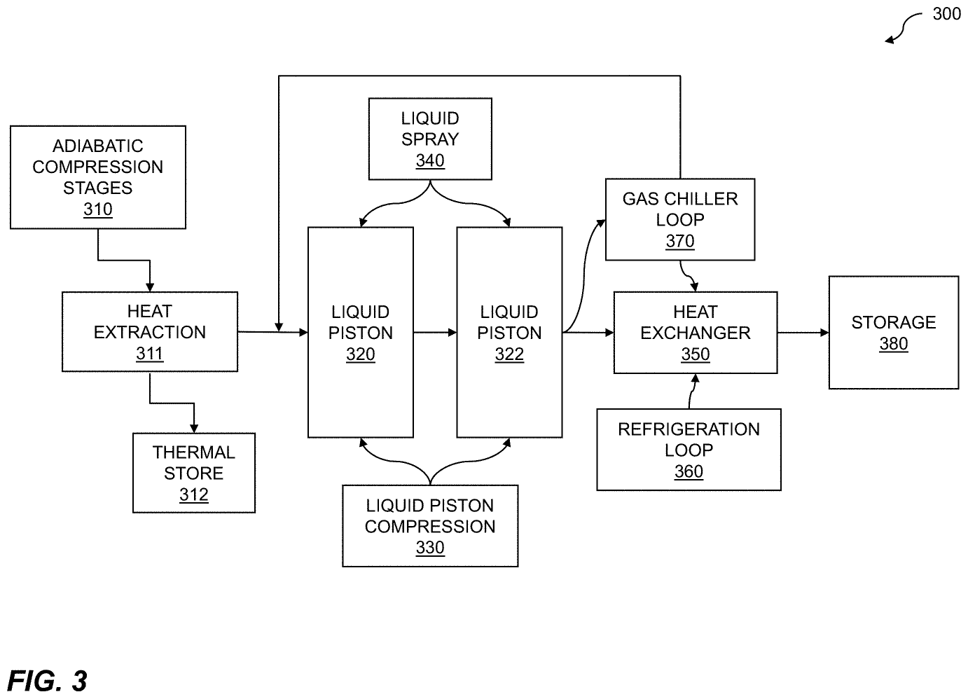

FIG. 3 is a block diagram of a compressed air energy system (CAES). Gas liquefaction includes controlling the state conversion or condensing of a gas from a vapor state to a liquid state. The liquefaction of the gas can be accomplished by changing the temperature of the gas, the pressure of the gas, or both. Gas liquefaction can be controlled using one or more energy management techniques for storing energy, recovering energy, converting energy from an energy type to a different energy type, and so on. The storing and recovering energy can include storing excess energy for later use, capturing energy from renewable energy sources to equalize energy availability, and the like. Liquid air can be produced by compressing air, controlling the temperature of the compressed air, and so on. The liquefied air that results from the compressing and cooling of the air can be stored in a vessel such as a pressure vessel, a tank such as a cryogenic storage tank, and so on. While using air such as the gas that is being compressed, cooled, and stored as described here, other gas can also be used. The liquid air energy system enables gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram of a liquid air energy system (CAES) 300 is shown. The block diagram 300 includes one or more adiabatic compression stages 310. The compression stages can include one or more varieties of compressors such as gas compressors. The one or more gas compressors can include centrifugal, reciprocating, rotary screw, and axial compressors. In embodiments, using two or more compressing stages enables the compressing of a gas adiabatically. The system 300 includes a heat extraction block 311. The heat extraction block removes heat generated by the adiabatic compression of the gas. Various heat extraction methods can be employed, such as direct contact of a gas over solids, direct contact of a gas with a liquid, heat exchanger form factors, and so on. The block diagram includes a thermal store 312. The thermal store can be used to store the heat extracted by the heat extraction block 311, and the extracted heat can include heat from the gas that can be compressed by the compression stages. The thermal store or thermal cell can include a bed of packings where the bed of packings can be used to store heat for an amount of time. The thermal cell can include a heat exchanger filled with a heat storing liquid. The heat storing liquid can include water, water mixed with other liquids such as glycol, mineral oils, synthetic thermal fluids, molten inorganic salts, molten metals, and the like.

The block diagram 300 can include one or more liquid pistons such as liquid piston 320 and liquid piston 322. A liquid piston comprises a vessel into which a liquid can be pumped, compressing a gas in its headspace. In embodiments, the gas includes environmental air, and the liquid includes water. Other gases and liquids can be used with or in place of the air, the water, or both the air and the water. The one or more liquid pistons can be used to compress or additionally compress a gas that can be compressed by the one or more compression stages. The block diagram 300 can include liquid piston compression 330. Liquid piston compression can be accomplished by pumping a liquid into one or more of the liquid pistons. In embodiments, the liquid that can be pumped into one or more of the liquid pistons can include water. The water can include water that can be obtained from a reservoir, a water tank, etc. The water can include water recycled from the CAES system. Discussed throughout, a compressed gas can be produced by compressing a gas adiabatically. A result of compressing a gas adiabatically is that the temperature of the gas increases, often significantly. The compressed gas can be cooled. The block diagram 300 can include a liquid spray 340. A liquid spray can be injected into one or more of the liquid pistons in order to cool or control the temperature of the gas that is compressed. The liquid spray can include a substance that is substantially similar to the gas and/or the liquid that can be contained within the liquid piston. In embodiments, cooling the first liquid piston compressor and/or the second liquid piston compressor can enable isothermal, rather than adiabatic, operation of the first liquid piston compressor and/or the second liquid piston compressor.

The block diagram 300 can include a heat exchanger 350. The heat exchanger can be used to cool a gas, such as a gas produced at a second pressure by the liquid piston 322. In embodiments, the cooling accomplishes liquefaction of the compressed gas at a second pressure. Since copious heat can be produced by the compression of a gas by the second liquid piston 322, a cooling loop can be required to remove the heat from the heat exchanger. The block diagram 300 can include a refrigeration loop 360. The refrigeration loop can be used to pre-cool the gas at the second pressure to facilitate its subsequent liquefaction. The refrigeration loop can include a compressor, a condenser, an expansion valve, an evaporator or expander, and so on. In addition to the cooling provided by the refrigeration loop, additional cooling can be provided by a gas chiller. The block diagram 300 can include a gas chiller loop 370. A liquid piston such as liquid piston 322 can be used to compress a gas that can be compressed by the compression stages and the liquid piston 320. The compressed gas can be expanded substantially isentropically in a turbine or engine, performing work. By the first law of thermodynamics, the energy content of the gas must decrease by an amount substantially equivalent to the work exported. Thus, expanding a gas as described can cause the temperature of the gas to lower. The gas chilled by expansion of the gas can be provided to the gas chiller loop. The gas chiller loop can further cool the gas being transferred through the heat exchanger 350. Discussed above and throughout, cooling the compressed gas at a second pressure using a heat exchanger can accomplish liquefaction of the compressed gas at a second pressure. The liquefied gas can be stored in a storage vessel, where the storage vessel can include a pressure tank, a cryogenic tank, thermal store, and so on. The block diagram can include compressed and/or liquefied gas storage 380. Cryogenic liquid storage can be accomplished by storing the cryogenic liquid in cryogenic container such as a double-walled, evacuated container. In embodiments, a cryogenic tank can be used to store one or more cryogenic liquid columns. For some applications, it may be advantageous for the fluid exiting liquid piston 322 or heat exchanger 350 to remain as a highly compressed gas rather than to undergo liquefaction. The highly compressed gas can be stored or otherwise used for energy storage, manipulation, gas processing, and so on.

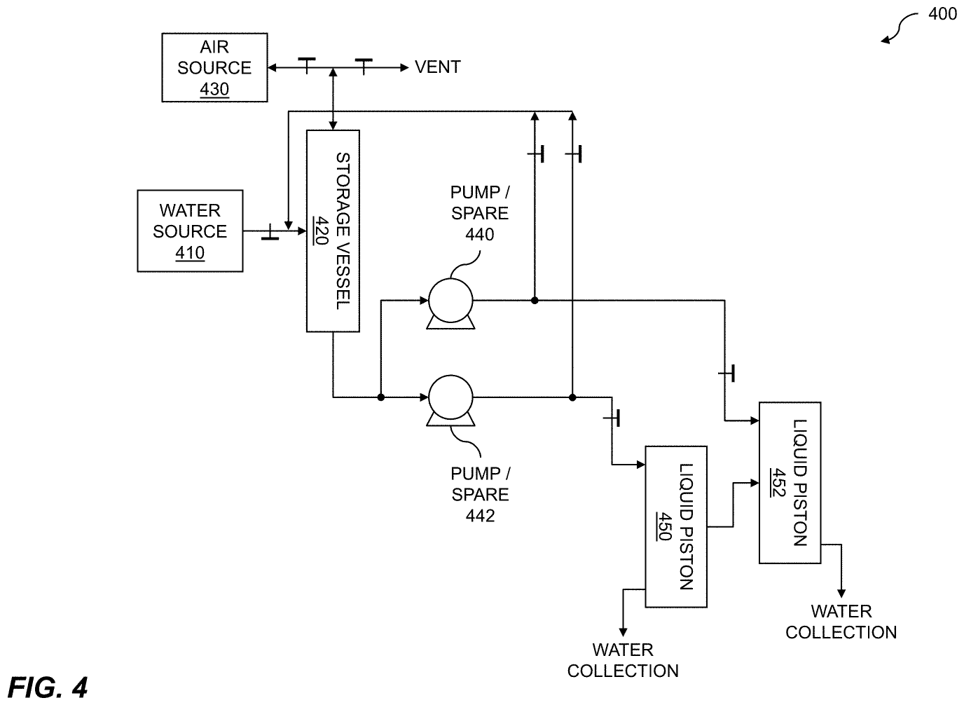

FIG. 4 is a system block diagram for liquid spray. The block diagram 400 can include a liquid source such as water source 410. While a water source is described here, other liquids can be used to cool a compressed gas within a liquid piston compressor. Water from the water source can be transferred to a storage vessel 420. The transfer can be accomplished using a pump, a pump-turbine, a gravity feed, and so on. The storage vessel can include a tank, a pressure tank, etc. The block diagram 400 can include an air source 430. The air source can be used to provide air to the storage vessel when liquid such as water is being pumped from the storage vessel, the vessel is being drained, and so on. The storage vessel can be further coupled to a vent, where the vent can allow a gas such as air to escape the storage vessel while the vessel is being filled. The system block diagram 400 can include one or more pumps and one or more spares associated with each pump, such as pump/spare 440 and pump/spare 442. The one or more pumps, and the spares associated with the one or more pumps, can be used to transfer liquid from the storage vessel 420 to one or more liquid pistons. In the system block diagram 400, two liquid pistons are shown, a first liquid piston 450 and a second liquid piston 452. The liquid that is pumped from the storage vessel into the one or more liquid pistons can be used to compress a gas within the one or more liquid pistons. The liquid within the one or more liquid pistons can be drained from the one or more liquid pistons. The water that originated at the water source and was pumped into the one or more liquid pistons can be collected. The collected water can be processed, where the processing can include filtration, decontamination, chemical treatment, etc., of the water prior to returning the water to the water source. In embodiments, additional water can be added to the water source to compensate for water losses associated with application of the liquid spray.

A liquid spray can be used to cool a compressed gas such as a compressed gas within a liquid piston compressor. The liquid spray can further remove excess generated heat that can result from compressing a gas within the liquid piston compressor. The droplets within the spray can absorb the generated heat. In embodiments, cooling the first liquid piston compressor can enable isothermal operation of the first liquid piston compressor. An isothermal process is one in which the temperature of the process remains substantially constant. Isothermal pressurizing can maintain a constant or near-constant temperature within the liquid piston. The liquid spray can include a substance substantially similar to the liquid within the liquid piston compressor, or the liquid spray can include a substance that is substantially dissimilar from the liquid within the liquid piston. The liquid spray enables gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

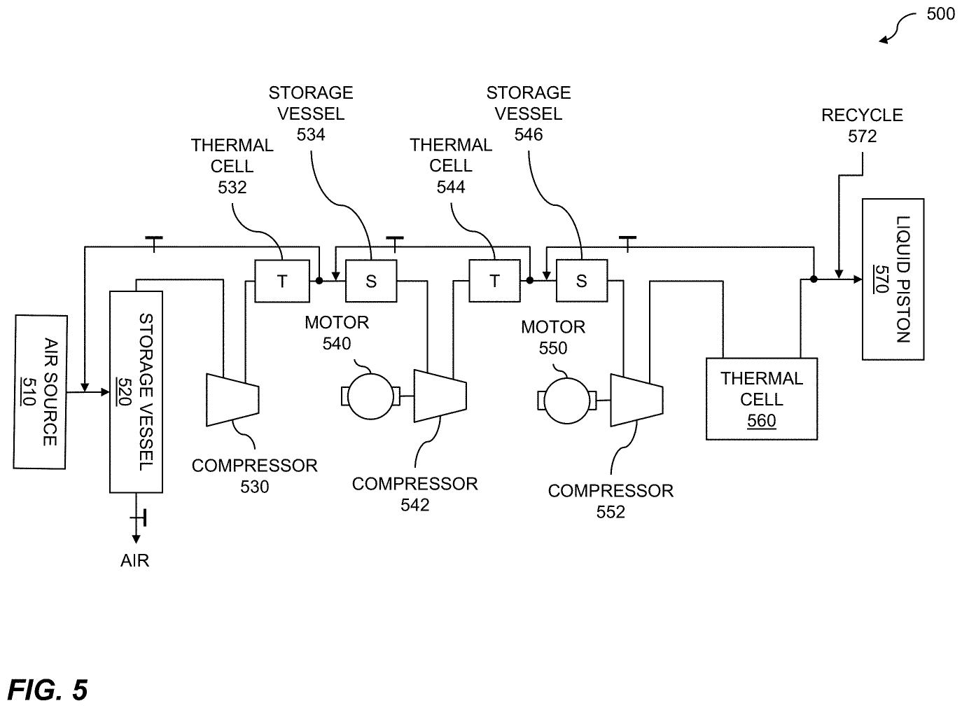

FIG. 5 is a system block diagram 500 for adiabatic compression before a first liquid piston. A liquid piston can be used to compress a gas within the liquid piston. The compressing of the gas can be accomplished by providing liquid to the liquid piston compressor. The gas that is compressed within the liquid piston can be compressed or “pre-compressed” prior to being transferred to the liquid piston compressor. The compressing of the gas prior to the gas being transferred to the liquid piston compressor can be accomplished using one or more compressing stages. The compressing can be accomplished adiabatically, where neither heat nor mass of the gas provided to the liquid piston compressor is lost to the environment surrounding the liquid piston compressor. The adiabatic compression before a first liquid piston enables gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram for adiabatic compression prior to a first liquid piston compressor is shown. The system block diagram can include a gas source such as air source 510. The air source can include environmental air, where the environmental air can be processed. Processing the environmental air can include filtration, decontamination, and so on. In embodiments, one or more gases other than air can be provided by a source such as air source 510. Air from the air source can be transferred to a storage vessel 520. The storage vessel can include a tank, a pressure vessel, and so on. The gas such as air within the storage vessel can be vented to the atmosphere using a valve. The valve can drain the storage vessel, can vent high pressure air to the atmosphere (e.g., safety valve), and the like. Air within the storage vessel can be compressed prior to transfer to a liquid piston. In embodiments, the compressing a gas adiabatically can be accomplished using two or more compressing stages. The system block diagram 500 includes a first compressor 530. Described throughout, gas compression can be accomplished using one or more types of gas compressors such as centrifugal, reciprocating, rotary screw, or axial compressors. The compressor 530 can be powered by various methods (not shown), including an electric motor, a diesel engine, a fluid under pressure, a mechanical motion converter, etc. In embodiments, the compressor 530 comprises a centrifugal compressor that compresses the gas to a first pressure. Recall that compressing a gas can cause the temperature of the gas to rise. The heat generated by compressing a gas can be extracted from the compressed gas and can either be discarded into the environment using an air cooler or cooling water, or can be stored in a thermal store such as a first thermal cell 532. In embodiments, the thermal store can include a bed of packings, a heat exchanger filled with a heat-storing liquid, and so on. The compressed gas produced by compressor 530 can be stored in a storage vessel such as storage vessel 534. A portion of cooled air can be fed back to the storage vessel 520. The air that is fed back can be stored in the storage vessel, can be used to condition the air from the air source, and so on.

Further compressors can be included in the system block diagram 500. The system block diagram can include a first motor-compressor pair. The first motor-compressor pair can include a motor 540 that operates an associated compressor 542. In embodiments, the first motor-compressor pair can comprise a reciprocating, a centrifugal, or an axial compressor. The motor-compressor pair can produce a compressed gas at a second pressure. The heat generated by compressing the gas to the second pressure can be extracted and stored in a second thermal cell 544. The thermal cell 544 can be substantially similar to the first thermal cell 532, or can be substantially different from that thermal cell. The gas that is compressed to the second pressure can be stored in storage vessel 546. The system block diagram 500 can include a second motor-compressor pair, comprising motor 550 and compressor 552. In embodiments, the second motor-compressor pair can comprise a reciprocating compressor. The second motor-compressor pair can compress the air to a third pressure. Heat generated by compressing the air to a third pressure can be extracted from the air and stored in a thermal store such as a third thermal cell 560. The system block diagram can include a liquid piston 570. The compressed air at the third pressure can be provided to a liquid piston 570 for further compression, for expansion where the gas expanded from the third pressure can perform work or provide refrigeration, etc. In addition to compressed air provided by the second motor-compressor pair, recycled air 572 can be provided to the liquid piston. The recycled air can include air that was expanded, air that was used to perform work or refrigeration, and so on. In embodiments, the work that is performed can include datacenter cooling.

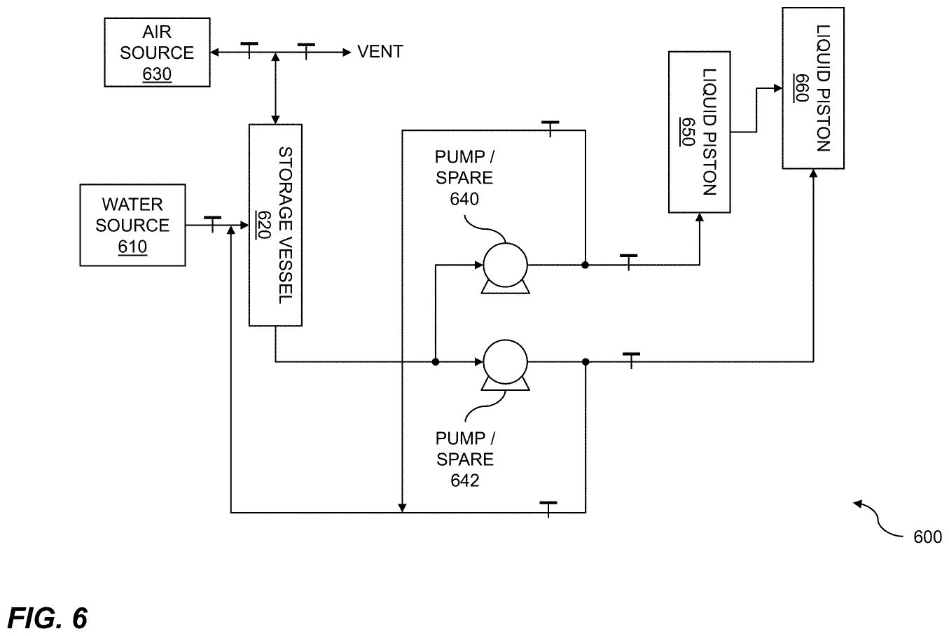

FIG. 6 is a system block diagram for water piston compression. A liquid piston such as a water piston can be used to compress a gas, to further compress a compressed gas, and so on. The liquid piston comprises a vessel into which a gas and a liquid can be provided. The gas within the liquid piston can be compressed or further compressed by providing additional liquid such as water into the liquid piston. In embodiments, a system can include more than one liquid piston. Using a liquid piston to compress a gas or to further compress a compressed gas enables gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram for water piston compression is shown. The system block diagram 600 can include a liquid source, where the liquid source can include a water source 610. The water from the water source can be provided to a storage vessel 620. The storage vessel can include a tank, a pressure tank, etc. A gas source such as air source 630 can be provided to the storage vessel 620. The air source can provide air to the storage vessel as the liquid within the storage vessel is pumped out, drained, or otherwise removed from the storage vessel. In addition to the air source, a vent can be coupled to the storage vessel. The vent can be used to vent gas such as air within the storage vessel to the atmosphere as water from the water source is pumped into the storage vessel.

The liquid such as water within the storage vessel can be pumped to one or more liquid pistons using one or more pumps. One or more spare pumps can be associated with each of the one or more pumps. The spare pumps can work in tandem with the pumps, can replace a failed pump or a pump removed for service or maintenance, and so on. The system block diagram 600 can include pump/spare 640 and pump/spare 642. The pump/spare 640 can be used to pump liquid from the storage vessel into a first liquid piston such as liquid piston 650. A portion of the liquid pumped by pump/spare 640 can be returned to the storage vessel. The pump/spare 642 can be used to pump liquid from the storage vessel into a second liquid piston such as liquid piston 660. A portion of the liquid pumped by pump/spare 642 can be returned to the storage vessel. In addition to using pump/spare 642 to provide liquid to liquid piston 660, liquid and/or gas can be transferred from liquid piston 650 to liquid piston 660. Other liquid pistons can be similarly coupled. In embodiments, the use of two or more compressing stages such as liquid piston compressing stages can accomplish compressing a gas adiabatically. The use of two or more compressing stages can aid gas liquefaction by enabling gas pressure that can range to 200 atmospheres or more.

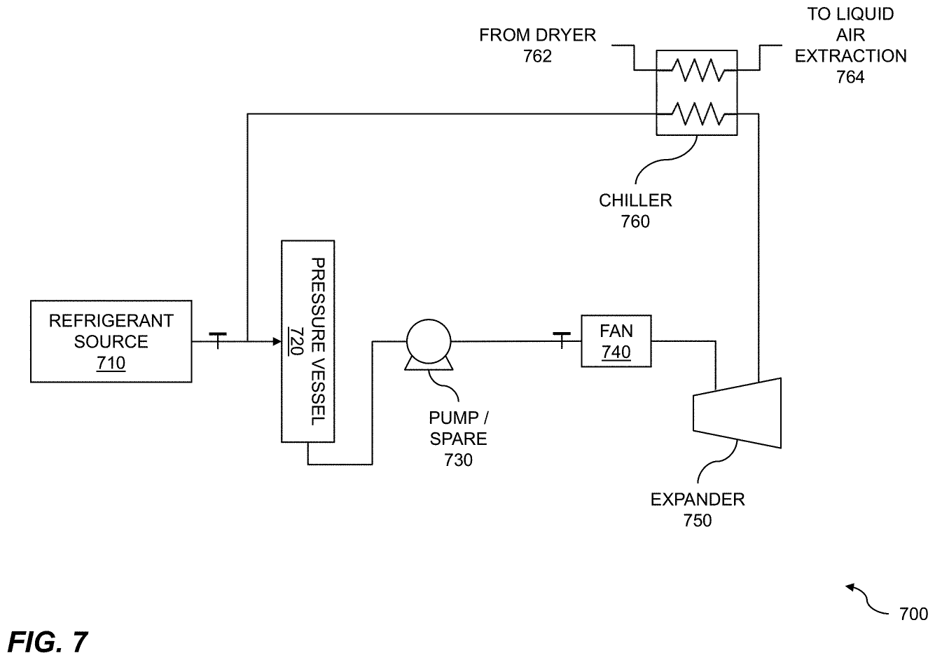

FIG. 7 is a system block diagram for a refrigeration loop. Discussed previously and throughout, compressing a gas can cause the temperature of the gas to increase. Heat associated with compressing the gas can be extracted and stored, where the stored heat can be used to perform work. One technique that can be used to extract heat from the compressed gas comprises a heat exchanger. The heat exchanger can be used to cool the compressed gas. To remove the extracted heat from the heat exchanger, a refrigeration loop can be used. Using a refrigeration loop to remove extracted heat from a heat exchanger supports gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram for a refrigeration loop is shown. A simple refrigeration loop can include a compressor, a condenser, a valve such as an expansion valve, an expander or evaporator, and so on. The system block diagram 700 can include a refrigerant source 710. The refrigerant source can include refrigerants such as chlorofluorocarbons (CFCs), hydrochlorofluorocarbons (HCFCs), fluorocarbons (FC), and natural refrigerants such as ammonia, carbon dioxide, hydrocarbons, air, and so on. The refrigerant can be provided to a pressure vessel such as pressure vessel 720. The pressure vessel can be used to provide refrigerant to the refrigeration loop, and the refrigerant source can be used to charge the refrigeration loop and to replace the last refrigerant, etc. The refrigerant, in the gaseous state, can be compressed using a compressor associated with the refrigeration loop. A pump, along with a spare pump 730, can be included in the system block diagram for moving fluid. The system block diagram can include a fan such as fan 740. The fan can be used to extract or discard excess heat that can be generated by compressing the refrigerant. The system block diagram 700 can include an expander such as expander 750. The compressed refrigerant that was cooled by the fan can be expanded by the expander 750. Expanding the gas can cause the refrigerant to cool, where the cooled refrigerant can be used to extract heat. The system block diagram can include a chiller or heat exchanger such as chiller 760. The cooled refrigerant can be used to extract heat from a gas or liquid that can also be provided to the chiller. In the system block diagram, compressed gas that can be dehydrated or dried 762 using a dryer (described below and throughout) can be chilled. The dried and chilled gas can be used for liquid air extraction 764 and other purposes. As an alternative to an expander 750, a suitable valve can be used. This works best when the refrigerant is cooled by the fan 740 to a substantially liquid state, and the valve reduces the pressure to a level that the refrigerant boils back to the gaseous state, acquiring latent heat of evaporation within the chiller 760 from the fluid that needs to be cooled. In this case, the chiller 760 is more commonly known as an evaporator.

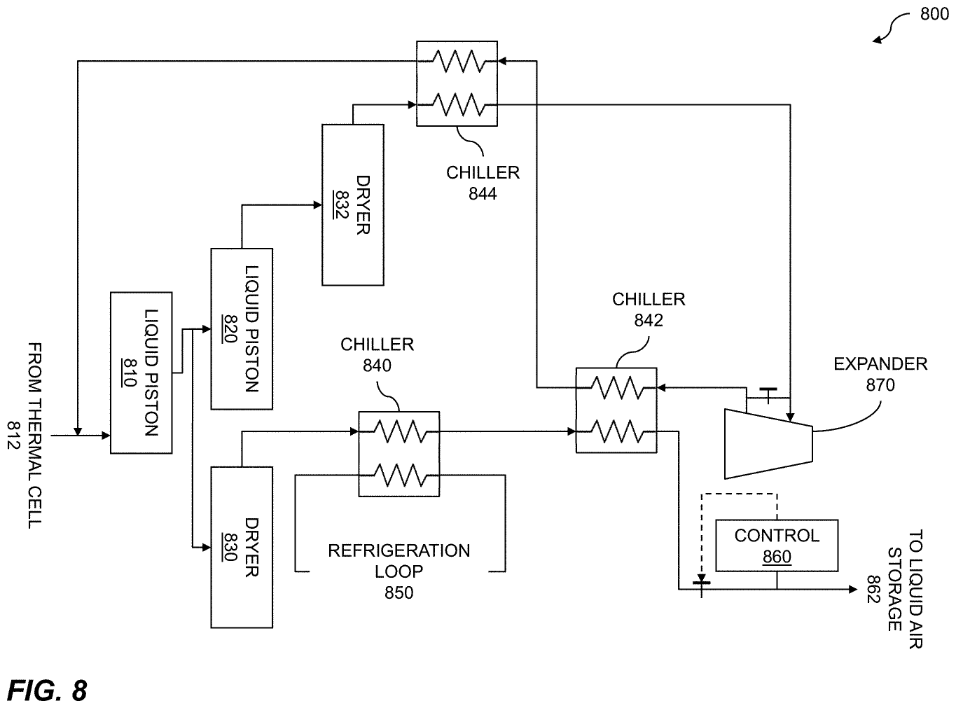

FIG. 8 is a system block diagram for liquid air extraction. Liquid air can be extracted by compressing air, controlling the temperature of the compressed air, and so on. The extracting liquid air can comprise one or more compression stages, one or more cooling stages, one or more drying stages, and so on. The liquid air that is extracted can be stored in liquid air storage, where the liquid air storage can include cryogenic storage. Liquid air extraction is supported by gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram for liquid air extraction is shown. The liquid air extraction can be accomplished using one or more liquid pistons. The liquid pistons can be used to compress a gas, to expand a gas or a liquefied gas, and so on. The liquid pistons can be used to generate liquefied gas, to recover energy from a liquefied gas, and to provide work. The system block diagram 800 includes a first liquid piston 810. In embodiments, the first liquid piston can include a water piston. A gas such as a compressed gas can be provided to the first liquid piston. The compressed gas that is provided to the first liquid piston can include compressed gas from a thermal cell 812. Note the compressed gas exiting the thermal cell 812 is at substantially cooled or ambient temperature. The liquid piston can be used to further compress the compressed gas from the thermal cell 812. The compressed gas from the first liquid piston 810 can be provided to a second liquid piston 820. The second liquid piston can be used to further compress the compressed gas provided by the first liquid piston. The heat of compression from the first and second liquid pistons can be substantially removed by liquid sprays or packings as previously discussed. The compressed gas emanating from the liquid pistons can be at substantially ambient temperatures. A gas that is compressed by the first liquid piston 810 and the gas that is compressed by the second liquid piston 820 can include vapor such as water vapor. Vapor within the compressed gas can be extracted using a dryer. The system block diagram 800 includes a dryer 830 associated with the first liquid piston 810, and a dryer 832 associated with the second liquid piston 820. The dryers 830 and 832 can remove some or all of the vapor within the compressed gas. The dryers can include mechanical dryers that can include absorbent substances, Freon chillers, electrostatic dryers, and so on. The dried compressed gas exiting dryer 830 can optionally be pre-cooled. The system block diagram 800 can include a chiller 840. The chiller can include a heat exchanger. Heat that is extracted from the gas can be removed using a refrigeration loop. The system block diagram 800 includes a refrigeration loop 850. The refrigeration loop can expel the heat obtained within the chiller to the atmosphere, can store the heat in a thermal cell, and so on.

The system block diagram 800 can include a chiller 842. The chiller 842, which can include a heat exchanger, can be used to further cool a compressed gas from the chiller 840. The chiller 842 can extract heat from compressed gas by using gas from the second liquid piston 820 that can be expanded (discussed shortly). The chiller 842 can accomplish liquefaction of the compressed gas. The system block diagram 800 includes control 860. The control can be used to control the flow of the liquefied gas to a storage vessel such as liquid air storage 862. The liquid air storage can include a pressure vessel, a cryogenic tank, and so on. The system block diagram can include a chiller 844. The chiller 844 can be used to remove some heat from the compressed gas produced by liquid piston 820 and dried by dryer 832. The chiller 844 can include a heat exchanger. The compressed gas from chiller 844 can be further chilled by expanding the gas. The system block diagram 800 can include an expander 870 which can expand the gas from chiller 844. Expansion of the gas by the expander can cause the temperature of the gas to drop. The expanded gas can be provided to chiller 842 and can be used to further cool the compressed gas from chiller 840 to its dew point temperature so that it is substantially in a liquid state, as just discussed. The expanded gas, now warmed, can be provided to chiller 844. The expanded gas can be used to remove some extracted heat from the dried, compressed gas provided by liquid piston 820. The expanded gas is warmed further by the chiller 844 based on the extracted heat. The expanded gas can be returned to the input of the first liquid piston 810 for reuse. Optionally, the liquid piston 810 can replaced by a mechanical compressor designed to perform a similar function.

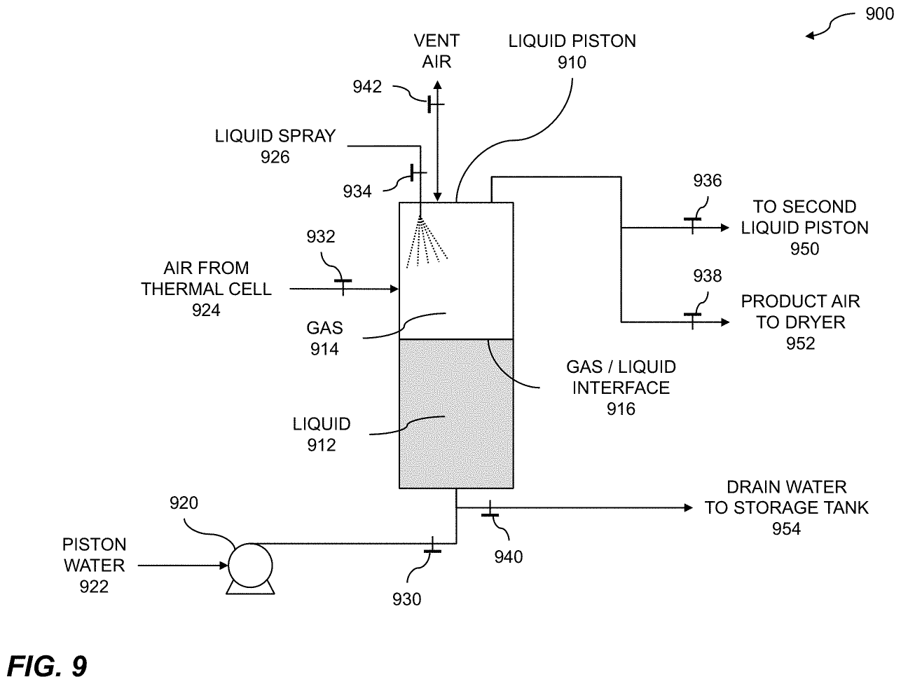

FIG. 9 is a system block diagram of a liquid piston compressor. A liquid piston compressor can include a vessel such as a pressure vessel to which a gas and a liquid can be provided. The gas can include a variety of gases, and the liquid can include various liquids. In embodiments, the gas includes environmental air, and the liquid includes environmental water. Providing further liquid to the liquid piston can cause the gas within the liquid piston to be compressed. The liquid piston compressor enables gas liquefaction using hybrid processing. A gas is compressed adiabatically to produce a compressed gas at a first pressure. The compressing a gas adiabatically is accomplished using two or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

A system block diagram of a liquid piston compressor is shown. The system block diagram 900 can include a liquid piston 910. The liquid piston can include a vessel such as a pressure vessel. A liquid 912 and a gas 914 can be provided to the liquid piston. In embodiments, the liquid that is provided to the liquid piston includes environmental water, and the gas that is provided can include environmental air. The liquid and the gas that are used within the liquid piston can be chosen to minimize mixing or absorption at a gas-liquid interface 916. The gas within the liquid piston can be compressed by providing liquid or additional liquid to the liquid piston. The providing liquid can be accomplished using a pump, a pump-turbine, and so on. The system block diagram 900 includes a pump 920. The pump 920 can be used to supply liquid such as piston water 922 to the liquid piston. Flow of pumped piston water into the liquid piston can be switched on or off by a switching valve 930. Gas such as air can be provided to the liquid piston. In the system block diagram 900, air from a thermal cell 924 can be provided to the liquid piston. Flow of the air from the thermal cell into the liquid piston can be controlled by a switching valve 932.

Discussed throughout, compressing a gas can generate prodigious heat. The compressed gas within the liquid piston compressor can be cooled by providing a liquid spray 926 into the liquid piston compressor. The liquid spray 926 can be controlled using valve 934. The liquid spray can include a substance substantially similar the liquid within the liquid piston compressor. The spray liquid can be chosen to minimize absorption of the gas into the spray liquid. Using a liquid spray substance that is substantially similar to the liquid contents of the liquid piston can simplify or eliminate the need to remove the spray substance from the piston liquid. The compressed gas from the liquid piston can be provided to an additional liquid piston. In the system block diagram 900, the compressed gas from liquid piston 910 can be provided to a second liquid piston 950. The flow of the compressed gas from the liquid piston to the second liquid piston can be controlled by switching valve 936. The compressed air from the liquid piston compressor 910 can also be processed, stored, and so on. In the system block diagram 900, the compressed gas from liquid piston 910 can be provided to a product air dryer 952. The product air dryer can remove vapor such as water vapor from the compressed gas. The flow of the compressed gas from liquid piston 910 to the product air dryer can be controlled by switching valve 938. The liquid within the liquid piston can be drained from the liquid piston. In the system block diagram 900, liquid such as water within the liquid piston can be drained to a drain water storage tank 954. The draining of the liquid piston can be controlled by switching valve 940. The water that is drained can be processed, returned to piston water, and so on. The switching valves are designed to switch quickly between an “on” mode, which permits flow of fluid, and an “off” mode, which shuts off flow. Air can be vented to or from the liquid piston 910 using valve 942.

FIG. 9 shows one pressure vessel which operates in a cyclic manner using the sequential steps of drain with gas fill, compress, exit, and back to drain with gas fill. A single vessel can only provide intermittent flow of compressed gas. Generally, a continuous flow of compressed gas is desired. In particular, when a liquid piston compressor interfaces with mechanical compressors, this could be crucial. Continuous operation can be achieved by using multiple (at least two) pressure vessels. The vessels would operate in an identical sequence, but out-of-phase with each other. For example, if three vessels are used, the vessels would be operated one-third of a cycle out-of-phase with each other. One vessel would be filling with gas while draining its liquid, another would be compressing gas using pumped-in liquid, and the third would be providing pressurized gas to downstream processes, such as another liquid piston or a dryer. Thus, there is always compressed air flowing out of at least one vessel. The total cycle time can be in the range of 1 to 1000 seconds. The operation is controlled by the switching valves, which dictate which fluid(s) flow in or out of which of the vessels.

In a usage example, one of the pressure vessels comprising a liquid piston 910 is initially filled with water. With valves 930, 936, and 938 closed, gas through the gas inlet valve 932 at, for example, nine atmospheres fills the vessel while pushing the water out through valve 940. This water, at 9 atm, feeds a pump, which pumps it into another pressure vessel, which is already filled with nine-atmosphere air, compressing the air to a target pressure. All valves are closed except valve 930, which is open. Once the target pressure is reached, valves 936 and/or 938 open to expel substantially all of the compressed gas at the target pressure into downstream equipment such as a second liquid piston or a dryer. When this pressure vessel is substantially filled with water, valves 936, 938, and 930 close and valves 932 and 940 open to admit a fresh dose of pressurized gas at 9 atm, while supplying water at 9 atm to the pump of an additional liquid piston pressure vessel, and the cycle thus continues.

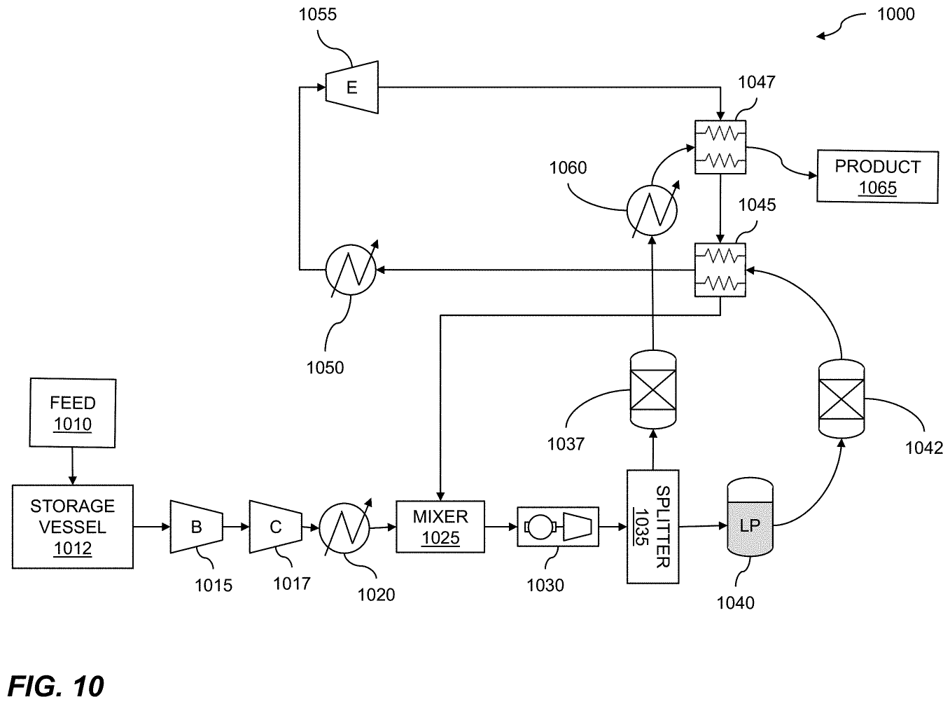

FIG. 10 is a system block diagram for hybrid compression. Discussed throughout, hybrid compression techniques can be used to produce liquid air or other liquefied gases. The hybrid compression techniques can be based on various types of compressors, use of one or more water pistons, and so on. The techniques can further include adiabatic techniques, isothermal techniques, and the like. In embodiments, one or more hybrid techniques can be used, where the hybrid techniques can be based on adiabatic techniques and liquid piston techniques for gas processing. The gas processing is based on gas liquefaction using hybrid processing. A gas is compressed adiabatically to produce a compressed gas at a first pressure. The compressing a gas adiabatically is accomplished using one or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

The system block diagram 1000 includes a feed 1010. The feed can include a gas such as air, an air constituent such as nitrogen, carbon dioxide, and so on. The air can be transferred to a storage vessel 1012, where the storage vessel can include a pressure vessel, a tank, a container, etc. The transferring can be accomplished using a blower, compressor, pump, pump-turbine, etc. The conversion of the air to liquid air includes one or more stages of compression and one or more stages of cooling. The compression can be accomplished adiabatically. In the system block diagram 1000, hybrid compression can include a blower 1015. The blower can accomplish moving the air, compressing the air, and so on. The blower can be based on various blower techniques, where the blower techniques can include a centrifugal blower such as a multiple-stage centrifugal blower, a positive displacement blower that can use rotary lobes, a rotary vane blower, and the like. The system block diagram 1000 can include a compressor 1017. The compressor can include a centrifugal compressor, a reciprocating compressor, a rotary compressor, a rotary screw compressor, and so on. The compressor can compress air such as atmospheric air to a pressure of a few atmospheres. In embodiments, a pressure of a few atmospheres can include 1 to 5 atmospheres, 1 to 10 atmospheres, 1 to 50 atmospheres, etc.

Adiabatic compression of a gas can cause the temperature of the gas to increase since its internal energy can increase by an amount equivalent to the work of compression that is performed on the gas. The temperature increase due to compression of the gas can be prodigious. The block diagram 1000 can include a chiller or cooler 1020. The cooler can be used to extract heat from the compressed gas. The extracted heat can be stored, where the storage of the extracted heat can be accomplished using a thermal store (not shown). The stored heat can be used to preheat a gas or liquid, perform work, and so on. The system block diagram 1000 can include a mixer 1025. The mixer can be used to mix the compressed, cooled air with return air. The return air can include air used to accomplish liquefaction (discussed further below). The system block diagram can include a motor/compressor 1030. The motor/compressor, which can be used to additionally compress the compressed air, can include a “conventional” compressor such as a centrifugal, reciprocating, rotary, or rotary screw compressor, and so on. The pressure to which the air can be compressed by compressor 1030 can include a pressure higher than the first pressure accomplished by the compressor 1017. The pressure can include a pressure such as a pressure within a range such as 5 to 50 atmospheres, and the like. The compressor 1017 and the compressor 1030 can provide multistage adiabatic compression of the air.

The system block diagram 1000 can include a splitter 1035. The splitter can be used to direct or divert a portion of the compressed gas. The diverted portion of the compressed gas can be processed to form a product such as liquefied gas (discussed below). The remaining portion of the gas can be used for processing the diverted portion of the gas as part of an auto-refrigeration liquefaction technique. The diverted portion of the gas can be dehumidified using a dryer 1037. The dryer can be used to remove vapor such as water vapor from a compressed gas. The dehumidification of the gas can prevent formation of rime or ice if the compressed gas is later chilled or decompressed. The system block diagram 1000 can include a liquid piston 1040. The portion of the gas that is not diverted by the splitter can be directed to the liquid piston (LP). The liquid piston can further compress the compressed gas produced by the compressor 1030. In embodiments, the gas that is pressurized by the liquid piston can be pressurized to a pressure up to 200 atmospheres or higher. Like the portion of the pressurized gas that was diverted by the splitter 1035, the pressurized gas produced by the liquid piston 1040 can also be dehumidified. The system block diagram 1000 can include a dryer 1042, where the dryer can be used to remove vapor such as water vapor from the pressurized gas processed by the liquid piston. The dried or dehumidified gas produced by dryer 1042 can be used as part of an auto-refrigeration subsystem. An auto-refrigeration subsystem can use a portion of the compressed gas to chill and liquefy the portion of the gas that was diverted by the splitter 1035.

The system block diagram 1000 can include a heat exchanger 1045. The heat exchanger 1045 can be used to cool the portion of the pressurized gas that was dried by the dryer 1042. The cooling can be accomplished using the chilled and expanded gas returning from an auto-refrigeration subsystem (discussed shortly below). The system block diagram 1000 can include a chiller 1050. The chiller can be used to further cool or chill the portion of the pressurized gas cooled by heat exchanger 1045. The system block diagram can include an adiabatic expander 1055. The adiabatic expander can be used to expand or reduce the pressure of the pressurized gas that was cooled by the chiller 1050, while performing work. From the first law of thermodynamics, an adiabatic expander has no heat entering or leaving the boundary walls, so the internal energy of the gas can decrease by the amount of work so exported. Hence the temperature of the gas can decrease. If the pressure drop across the expander is large enough, the gas can get cooled below the dew point of the diverted gas from dryer 1037. The expander can be thermodynamically isentropic, which establishes the thermodynamic maximum amount of work that can be recovered from a given gas under adiabatic conditions, expanding between two given pressures. More realistically, the expander can be substantially isentropic, or equivalently, possess a high isentropic efficiency. The expander can have an isentropic efficiency of at least 60%. That means, the amount of work recovered or exported is at least 60% of the thermodynamic maximum. The expander can be a centrifugal or axial turbine, or a reciprocating device. The expander is typically connected to a “load” which absorbs the work being exported by the expander. The system block diagram can include a second heat exchanger 1047. The heat exchanger 1047 can be used to extract heat from a gas as part of a gas liquefaction technique. The gas used to extract heat using heat exchanger 1047 can be directed to heat exchanger 1045 to remove heat from the gas produced by dryer 1042, as discussed previously. The gas from heat exchanger 1045 can then be directed back to mixer 1025. The gas returned to mixer 1025 can then be pressurized using compressors 1030 and 1040, dried using dryer 1042, and returned to the auto-refrigeration subsystem including chiller 1050, expander 1055, and heat exchangers 1047 and 1045. Preferably, the pressure drop across expander is sufficient to cool its exhaust to below the dew point of the diverted gas from dryer 1037. In this case, the diverted gas can liquefy. Preferably, the split flow fraction at splitter 1035 is so adjusted that substantially all of this gas is liquefied into product 1065. Liquefaction can be performed on the portion of the compressed gas that was diverted by the splitter 1035 and dried by the dryer 1037. The portion of the compressed gas that was diverted and dried can be chilled using a cooler, a chiller, and so on. The system block diagram can include a chiller 1060. The chiller 1060 can be used to extract heat from the diverted and dried pressurized gas. The chiller 1060 can comprise a conventional refrigeration subsystem. The pressurized gas that was chilled by chiller 1060 can be directed to heat exchanger 1047 for further cooling. The further cooling can result in a product 1065, where the product can comprise a liquefied gas such as liquefied air, liquefied nitrogen, liquefied carbon dioxide, etc. The liquefied gas can be stored in a storage vessel, a tank, and so on. In embodiments, the storage vessel in which the liquefied gas is stored can comprise a cryogenic tank.

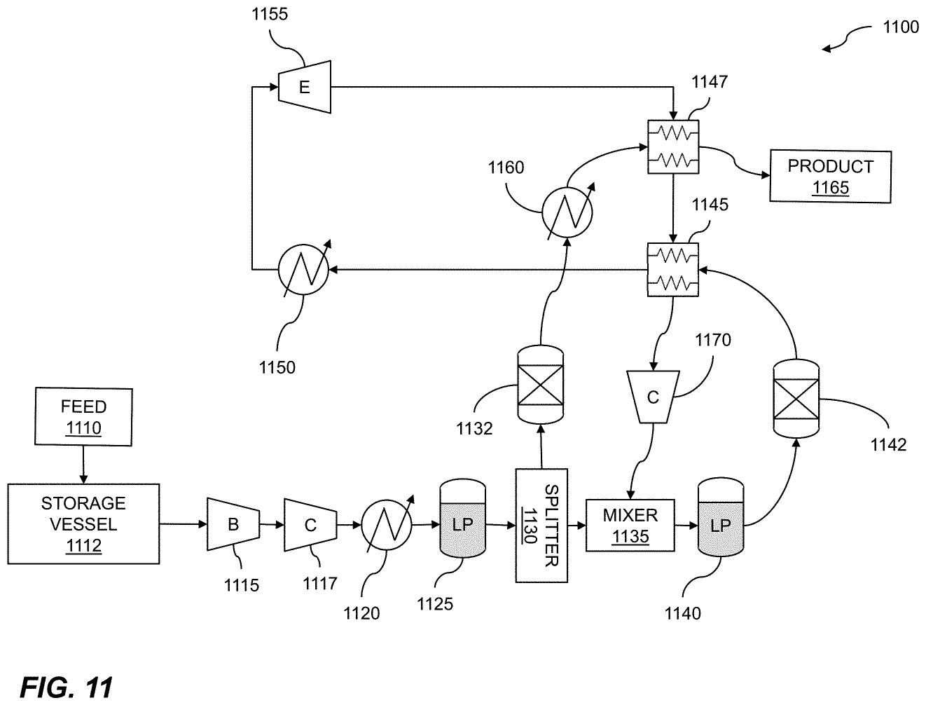

FIG. 11 is a system block diagram for hybrid compression with an additional liquid piston. Discussed previously, hybrid compression techniques can be used separately or in combination with cooling and/or chilling techniques to produce a product such as a liquefied gas. The liquefied gas can include liquefied air or other liquefied gases. The techniques can be based on various types of compressors, water pistons, and so on. The hybrid techniques can include adiabatic techniques, isothermal techniques, etc. In embodiments, the gas processing is based on gas liquefaction using hybrid processing. A gas is compressed adiabatically to produce a compressed gas at a first pressure. The compressing a gas adiabatically is accomplished using one or more compressing stages. Heat is extracted from the compressed gas at a first pressure. The heat that is extracted is collected in a thermal store. The compressed gas at a first pressure is further compressed. The further compressing is accomplished using a first liquid piston compressor. The further compressing produces a compressed gas at a second pressure. The first liquid piston compressor is cooled using a liquid spray. The compressed gas at a second pressure is cooled using a heat exchanger. The cooling accomplishes liquefaction of the compressed gas at a second pressure.

The system block diagram 1100 includes a feed 1110, where the feed can include a gas such as air, an air constituent such as nitrogen, carbon dioxide, etc. The gas can be transferred to a storage vessel 1112 such as a pressure vessel, a tank, a container, and the like. The transferring can be accomplished using a blower, compressor, pump, pump-turbine, etc. The conversion of a gas such as air to liquid air includes one or more stages of compression and one or more stages of cooling. The compression can be accomplished adiabatically. In the system block diagram 1100, hybrid compression can include a blower 1115, where the blower can accomplish moving the air, compressing the air, and so on. The blower can be based on various blower techniques such as a centrifugal blower including a multiple-stage centrifugal blower, a positive displacement blower using rotary lobes, a rotary vane blower, etc. The system block diagram 1100 can include a compressor 1117. The compressor can include a centrifugal, reciprocating, rotary, or rotary screw compressor, and so on. The compressor can compress air such as atmospheric air to a pressure of a few atmospheres. The atmospheric air can be filtered prior to being directed to the blower to remove contaminants such a pollen, dust, debris, and so on. In embodiments, a pressure of a few atmospheres accomplished by the blower can include 1 to 5 atmospheres, 1 to 10 atmospheres, 1 to 50 atmospheres, etc.

As discussed, compressing a gas adiabatically substantially increases its temperature due to the work of compression impressed on the gas. The block diagram 1100 can include a chiller or cooler 1120. The cooler can be used to extract heat from the compressed gas, where the extracted heat can be stored or discarded to the environment. The extracted heat can be stored using a thermal store (not shown). The stored heat can be used to preheat a gas or liquid, to perform work, etc. The system block diagram can include a first liquid piston 1125. The liquid piston can be used to further compress the compressed air to a second pressure. The second pressure to which the air can be compressed by liquid piston 1125 can include a pressure higher than the first pressure accomplished by the compressor 1117, such as a pressure within a range such as 5 to 50 atmospheres, and the like. Preferably, this pressure is less than the critical pressure of the gas being compressed. The system block diagram 1100 can include a splitter 1130. The splitter can be used to divert a portion of the compressed gas produced by liquid piston 1125. The diverted portion of the compressed gas can be processed to form a product such as liquefied gas (discussed below) if its pressure is less than its critical pressure. The remaining portion of the gas can be used for processing the diverted portion of the gas from the splitter, as part of a liquefaction technique. The diverted portion of the gas can be dehumidified or dried using a dryer 1132. The dryer can be used to remove vapor such as water vapor from a compressed gas. The dehumidification of the gas can prevent formation of rime or ice if the compressed gas is later chilled or decompressed.

The system block diagram 1100 can include a mixer 1135. The mixer can be used to mix the compressed, cooled air with return air. The return air can include air used to accomplish liquefaction (discussed further below). The return air can include air used by an auto-refrigeration subsystem. The system block diagram 1100 can include a second liquid piston 1140. The portion of the gas that is not diverted by the splitter can be directed to the second liquid piston (LP). The second liquid piston can further compress the compressed gas produced by the first liquid piston 1125. In embodiments, the gas that is pressurized by the second liquid piston can be pressurized to a pressure up to 200 atmospheres or higher. The pressurized gas produced by the second liquid piston 1140 can also be dehumidified or dried. The system block diagram 1100 can include a dryer 1142, where the dryer can be used to remove vapor such as water vapor from the pressurized gas processed by the liquid piston. The dried or dehumidified gas produced by dryer 1142 can be used as part of an auto-refrigeration subsystem. An auto-refrigeration subsystem can use a portion of the compressed gas to chill and liquefy the portion of the gas that was diverted by the splitter 1130.

The system block diagram 1100 can include a heat exchanger 1145. The heat exchanger 1145 can be used to cool the portion of the pressurized gas that was dried by the dryer 1142. The cooling can be accomplished using the chilled and expanded gas returning from an auto-refrigeration subsystem (discussed shortly below). The system block diagram 1100 can include a chiller 1150. The chiller can be used to further cool or chill the portion of the pressurized gas cooled by heat exchanger 1145. The system block diagram can include an expander 1155. The expander can be used to expand or reduce the pressure of the pressurized gas that was cooled by the chiller 1150, while performing work. From the first law of thermodynamics, an adiabatic expander has no heat entering or leaving the boundary walls, so the internal energy of the gas can decrease by the amount of work so exported. Hence its temperature can decrease. If the pressure drop across the expander is large enough, the gas can be cooled below the dew point of the diverted gas from dryer 1132. The expander can be thermodynamically isentropic, which establishes the thermodynamic maximum amount of work that can be recovered from a given gas under adiabatic conditions, expanding between two given pressures. More realistically, the expander can be substantially isentropic, or equivalently, can possess a high isentropic efficiency. The expander can have an isentropic efficiency of at least 60%. This means that the amount of work recovered or exported is at least 60% of the thermodynamic maximum. The expander can be a centrifugal or axial turbine, or a reciprocating device. The expander is typically connected to a “load” which absorbs the work being exported by the expander. The system block diagram can include a second heat exchanger 1147. The heat exchanger 1147 can be used to further extract heat from a gas as part of a gas liquefaction technique. The gas used to extract heat using heat exchanger 1147 can be directed to heat exchanger 1145 to cool the gas exiting the dryer 1142, as discussed previously. The gas from heat exchanger 1145 can then be directed back to mixer 1135. The gas returned to mixer 1135 can be optionally pressurized using compressor 1170 before being mixed in mixer 1135 and sent back into liquid piston 1140. Liquefaction can be performed on the portion of the compressed gas that was diverted by the splitter 1130 and dried by the dryer 1132. The portion of the compressed gas that was diverted and dried can be chilled using a cooler, a chiller, and so on. The system block diagram can include a chiller 1160. The chiller 1160 can be used to extract heat from the diverted and dried pressurized gas. The pressurized gas that was chilled by chiller 1160 can be further cooled using heat exchanger 1147. The further cooling can result in a product 1165, where the product can comprise a liquefied gas such as liquefied air, liquefied nitrogen, liquefied carbon dioxide, liquefied natural gas (LNG), etc. The liquefied gas can be stored is a storage vessel, a tank, and so on. In embodiments, the storage vessel in which the liquefied gas is stored can comprise a cryogenic tank.

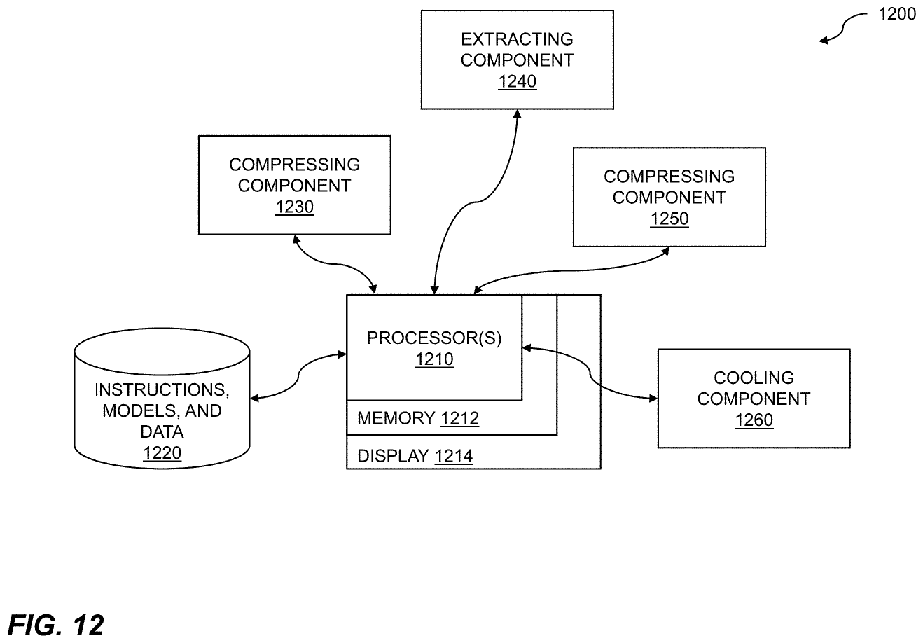

FIG. 12 is a system diagram for gas processing. Enabling of a gas processing system is based on gas liquefaction using hybrid processing. A gas is compressed adiabatically to produce a compressed gas at a first pressure. Heat is extracted from the compressed gas at a first pressure. The heat that is extracted is collected in a thermal store. The compressed gas at a first pressure is further compressed, wherein the further compressing is accomplished using a first liquid piston compressor, and wherein the further compressing produces a compressed gas at a second pressure. Cooling the first liquid piston compressor is accomplished using a liquid spray. Cooling the first liquid piston compressor enables isothermal operation of the first liquid piston compressor. The compressed gas at a second pressure is cooled using a heat exchanger, wherein the cooling accomplishes liquefaction of the compressed gas at a second pressure. The compressed gas at a second pressure is dried before liquefaction occurs. The gas that was liquefied is used to perform work. The liquefied gas and the stored heat are used to provide a variety of functions including energy storage, providing heat, and providing cooling.

The system 1200 can include one or more processors 1210 and a memory 1212 which stores instructions. The memory 1212 is coupled to the one or more processors 1210, wherein the one or more processors 1210 can execute instructions stored in the memory 1212. The memory 1212 can be used for storing instructions, for storing databases for liquefaction systems, for storing switching valve and non-return valve configurations, and the like. Information regarding the gas liquefaction using a hybrid processing system can be shown on a display 1214 connected to the one or more processors 1210. The display can comprise a television monitor, a projector, a computer monitor (including a laptop screen, a tablet screen, a netbook screen, and the like), a smartphone display, a mobile device, or another electronic display.

The system 1200 includes instructions, models, and data 1220. The data can include information on gas liquefaction systems; information on the controlling of switching valves, non-return valves, or smart valves; metadata about liquefaction; and the like. In embodiments, the instructions, models, and data 1220 are stored in a networked database, where the networked database can be a local database, a remote database, a distributed database, and so on. The instructions, models, and data 1220 can include instructions for adiabatically compressing a gas to produce a compressed gas at a first pressure. The compressing a gas adiabatically can be accomplished using two or more compression stages. The compression stages can include centrifugal compression, reciprocating compression, rotary compression, rotary screw compression, and so on. The instructions, models, and data can further include instructions for extracting heat from the compressed gas at a first pressure. In embodiments, the heat can be extracted using a heat exchanger. The heat that is extracted can be collected in a store. In embodiments, the heat that is extracted is collected in a thermal store. The collected heat can be used for various purposes including preheating of a gas or liquid, performing work, and so on. The instructions, models, and data can further include instructions for further compressing the compressed gas at a first pressure. The further compressing is accomplished using a first liquid piston compressor, and the further compressing produces a compressed gas at a second pressure. Embodiments can include drying the compressed gas at a second pressure before liquefaction occurs. The drying the gas can accomplish removing vapor such as water vapor. The removing vapor from the gas can prevent ice-up or freeze-up of the compressors, the liquid piston, associated valves, and so on. The instructions, models, and data can further include instructions for cooling the compressed gas at a second pressure using a heat exchanger, wherein the cooling accomplishes liquefaction of the compressed gas at a second pressure. In embodiments, the heat exchanger can be cooled using a refrigeration system. The instructions, models, and data can further include instructions for performing work using the gas that was liquefied. In embodiments, the work can include cooling such as cooling of a datacenter. The work can further include spinning a turbine to produce energy such as electrical energy. The instructions, models, and data can further include instructions for controlling switching valves which enable the pressurized gas to be liquefied, stored in a thermal store, stored in a cryogenic container, pushed into a second vessel such as a second liquid piston, and so on.

The system 1200 includes a compressing component 1230. The compressing component 1230 can compress a gas adiabatically to produce a compressed gas at a first pressure. Recall that for an adiabatic process, neither heat nor mass is transferred between the adiabatic process and the environment that surrounds the process. The compressing can be accomplished using a variety of techniques including a piston, a compressor, and so on. In embodiments, the compressing a gas adiabatically can be accomplished using two or more compressing stages. The compressing stages can be substantially similar compressing stages or substantially different compressing stages. The compressing stages can be based on various types of compressors such as a centrifugal compressor, a reciprocating compressor, a rotary screw compressor, an axial compressor, and so on. In embodiments, the two or more compressing stages can include one or more of a centrifugal compressor and a reciprocating compressor. The system 1200 includes an extracting component 1240. The extracting component 1240 can extract heat from the compressed gas at a first pressure. Recalling the ideal gas law, PV=nRT, increasing the pressure of a gas can be accomplished by reducing the volume, increasing the amount of gas, increasing the temperature of the gas, and so on. Compressing a gas can cause the temperature of the gas to increase. The extracting heat from the gas can cool the gas, maintain the gas at a constant temperature, and the like. The extracted heat can be stored for later use. In embodiments, the heat that is extracted can be collected in a thermal store. The thermal store can be based on various techniques including molten salt or molten aluminum, storing the heat in a manmade structure such as a tank or a natural structure such as a cavern, and so on. In embodiments, the thermal store comprises a bed of packings. Further techniques for thermal storage can be used. In embodiments, the thermal store can include a heat exchanger filled with a heat storing liquid.

The system 1200 includes a further compressing component 1250. The further compressing component 1250 can further compress the compressed gas at a first pressure, wherein the further compressing is accomplished using a first liquid piston compressor, and wherein the further compressing produces a compressed gas at a second pressure. In embodiments, the operation of the further compressing component can be accomplished by the compressing component or by a separate component. A liquid piston compressor can comprise a vessel into which gas, liquid, or both gas and liquid can be pumped and released. In embodiments, a piston liquid such as water is pumped into the liquid piston to increase the pressure of the gas at a first pressure to produce a compressed gas at a second pressure. The system 1200 includes a cooling component 1260. The cooling component 1260 can cool the compressed gas at a second pressure using a heat exchanger, wherein the cooling accomplishes liquefaction of the compressed gas at a second pressure. Various techniques can be used to accomplish the cooling. In embodiments, the heat exchanger can be cooled using a refrigeration system. The refrigeration system can include a standard refrigeration system which can include a compressor, a condenser, an expansion valve, an evaporator, and so on. Other cooling techniques can be used. Further embodiments include cooling the first liquid piston compressor using a liquid spray. The liquid spray can include one or more liquids. In embodiments, the liquid spray comprises water. The cooling can be used to cool the compressed gas, to manage the operation of the gas processing system, and so on. In embodiments, cooling the first liquid piston compressor can enable isothermal operation of the first liquid piston compressor. The liquid spray is introduced into the first liquid piston in a region occupied by the gas.

The system 1200 can include a system for gas processing comprising: a memory which stores instructions; one or more processors coupled to the memory wherein the one or more processors, when executing the instructions which are stored, are configured to: compress a gas adiabatically to produce a compressed gas at a first pressure; extract heat from the compressed gas at a first pressure; and further compress the compressed gas at a first pressure, wherein the further compressing is accomplished using a first liquid piston compressor, and wherein the further compressing produces a compressed gas at a second pressure. Disclosed embodiments include a computer program product embodied in a non-transitory computer readable medium for gas processing, the computer program product comprising code which causes one or more processors to perform operations of: compressing a gas adiabatically to produce a compressed gas at a first pressure; extracting heat from the compressed gas at a first pressure; and further compressing the compressed gas at a first pressure, wherein the further compressing is accomplished using a first liquid piston compressor, and wherein the further compressing produces a compressed gas at a second pressure.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for gas processing comprising:
compressing a gas adiabatically to produce a compressed gas at a first pressure;
extracting heat from the compressed gas at a first pressure; and
further compressing the compressed gas at a first pressure, wherein the further compressing is accomplished using a first liquid piston compressor, and wherein the further compressing produces a compressed gas at a second pressure.

2. The method of claim 1 further comprising cooling the compressed gas at a second pressure using a heat exchanger wherein the cooling accomplishes liquefaction of the compressed gas at a second pressure.

3. The method of claim 2 wherein the heat exchanger is cooled using a refrigeration system.

4. The method of claim 1 further comprising additionally compressing a portion of the compressed gas at a second pressure, using a second liquid piston compressor, to produce a compressed gas at a third pressure.

5. The method of claim 4 further comprising cooling the second liquid piston compressor using a liquid spray.

6. The method of claim 5 wherein cooling the second liquid piston compressor enables isothermal operation of the second liquid piston compressor.

7. The method of claim 1 further comprising expanding the compressed gas at the second pressure to provide refrigeration below a target dew point temperature.

8. The method of claim 7 wherein the expanding is substantially isentropic.

9. The method of claim 7 wherein the refrigeration is employed to generate liquefied gas at a pressure above a target dew point pressure.

10. The method of claim 7 further comprising feeding the compressed gas at the second pressure that was expanded back into an input of an adiabatic compressor used in the compressing the gas adiabatically.

11. The method of claim 7 further comprising feeding the expanded gas back into the first liquid piston compressor.

12. The method of claim 1 wherein the first liquid piston compressor operates substantially adiabatically.

13. The method of claim 1 wherein the heat that is extracted is collected in a thermal store.

14. The method of claim 13 further comprising using the gas that was liquefied to perform work.

15. The method of claim 14 wherein the work that is performed is enabled by the heat collected in the thermal store.

16. (canceled)

17. The method of claim 13 wherein the thermal store comprises a bed of packings.

18. The method of claim 13 wherein the thermal store comprises a heat exchanger filled with a heat storing liquid.

19. The method of claim 1 further comprising storing the gas that was liquefied for future use.

20. (canceled)

21. The method of claim 1 wherein the gas comprises environmental air.

22. The method of claim 1 wherein the compressing a gas adiabatically is accomplished using two or more compressing stages.

23. The method of claim 1 further comprising cooling the first liquid piston compressor using a liquid spray.

24. The method of claim 23 wherein the liquid spray is conditioned to an environmental temperature.

25. (canceled)

26. The method of claim 23 wherein cooling the first liquid piston compressor enables isothermal operation of the first liquid piston compressor.

27. The method of claim 23 further comprising drying the compressed gas at a second pressure before liquefaction occurs.

28. The method of claim 1 further comprising cooling the first liquid piston compressor using packing.

29-30. (canceled)

31. A computer program product embodied in a non-transitory computer readable medium for gas processing, the computer program product comprising code which causes one or more processors to perform operations of:
compressing a gas adiabatically to produce a compressed gas at a first pressure;
extracting heat from the compressed gas at a first pressure; and
further compressing the compressed gas at a first pressure, wherein the further compressing is accomplished using a first liquid piston compressor, and wherein the further compressing produces a compressed gas at a second pressure.

32. A system for gas processing comprising:
a memory which stores instructions;
one or more processors coupled to the memory wherein the one or more processors, when executing the instructions which are stored, are configured to:
compress a gas adiabatically to produce a compressed gas at a first pressure;
extract heat from the compressed gas at a first pressure; and
further compress the compressed gas at a first pressure, wherein the further compressing is accomplished using a first liquid piston compressor, and wherein the further compressing produces a compressed gas at a second pressure.
